(19) United States
(12) Patent Application Publication
(10) Pub. No.: US 2010/0023543 A1
(43) Pub. Date: Jan. 28, 2010

(54) METHOD FOR SUPPORTING UNCHECKED CLASSIFICATION WITHIN A SERVICE REGISTRY

(75) Inventors: Bernard Zdzislaw Kufluk, Southampton (GB); John Colgrave, Eastleigh (GB); Yi San Zhao, Beijing (CN); Pu Zhu, Beijing (CN)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/177,289

(22) Filed: Jul. 22, 2008

(51) Int. Cl. G06F 17/30

(52) U.S. Cl. 707/102; 707/E17.005; 707/E17.116

(57) ABSTRACT

During synchronization of data between service registries, certain unchecked classification and taxonomy data may not synchronize correctly leaving valuable data unused in the source registry. The present application provides for the creation of a generic object in the destination service registry to enable the synchronization to correctly map the taxonomy and classification data from a source service registry to a destination service registry and the auto format of data to conform to the requirements of the destination service registry.

### TECHNICAL FIELD

The present disclosure generally relates to the field of internet service registries, and more particularly to representation of unchecked classifications in a service registry to enable synchronization with another service registry.

### BACKGROUND

The present disclosure is directed at the use of a service registry consisting of a searchable database listing internet service definitions provided by one entity for discovery and use by another. Service Registries referenced in this application include: 1) Universal Description Discovery and Integration (UDDI), and 2) WebSphere Service Registry and Repository (WSRR). Classifications in a service registry defining a service may be checked or unchecked depending on the validation of the data before its release to a user. Unchecked classifications in a service registry are those data not validated before release to a user and the use of which is unrestricted. Prior art synchronization tools are able to update limited checked classifications between each type of service registry as the other is changed but are unable to synchronize unlimited unchecked classifications.

### SUMMARY

A method for supporting unchecked classifications within a service registry including, but not limited to identifying at least one source service registry with a plurality of source service entries, identifying at least one destination service registry containing a plurality of destination service entries, adding metadata to said source service registry as an unchecked classification system for each source service entry, extracting data from said source service entry, further including, extracting a name, extracting a value, extracting a reference to said unchecked classification system, applying said data from said source service registry to said destination service registry, further including, altering the format of extracted data to conform to a restriction of data types in the destination service registry, creating a generic object in said destination service registry in addition to said destination service entry, synchronizing said name, value and unchecked classification system from said source service entry to said destination service entry and said generic object.

### BRIEF DESCRIPTION OF THE DRAWINGS

The numerous advantages of the disclosure may be better understood by those skilled in the art by reference to the accompanying figures in which:

FIG. 1 offers a flowchart view of a preferred method of the present invention to support unchecked classifications in a service registry;

FIG. 2 represents a table listing an example of the data possibly synchronized between a UDDI based registry and a WSRR;

FIG. 3 represents a preferred view of Unchecked Taxonomy Mapping (UTM) between entries in a UDDI registry and a generic object created in a WSRR;

FIG. 4 represents a table listing an example of the data possibly synchronized between a UDDI based registry and a WSRR; and

FIG. 5 represents a table of the preferred outcome of the format change of extracted data conforming to the requirements of the destination service registry.

### DETAILED DESCRIPTION

Reference will now be made in detail to the subject matter disclosed, which is illustrated in the accompanying drawings.

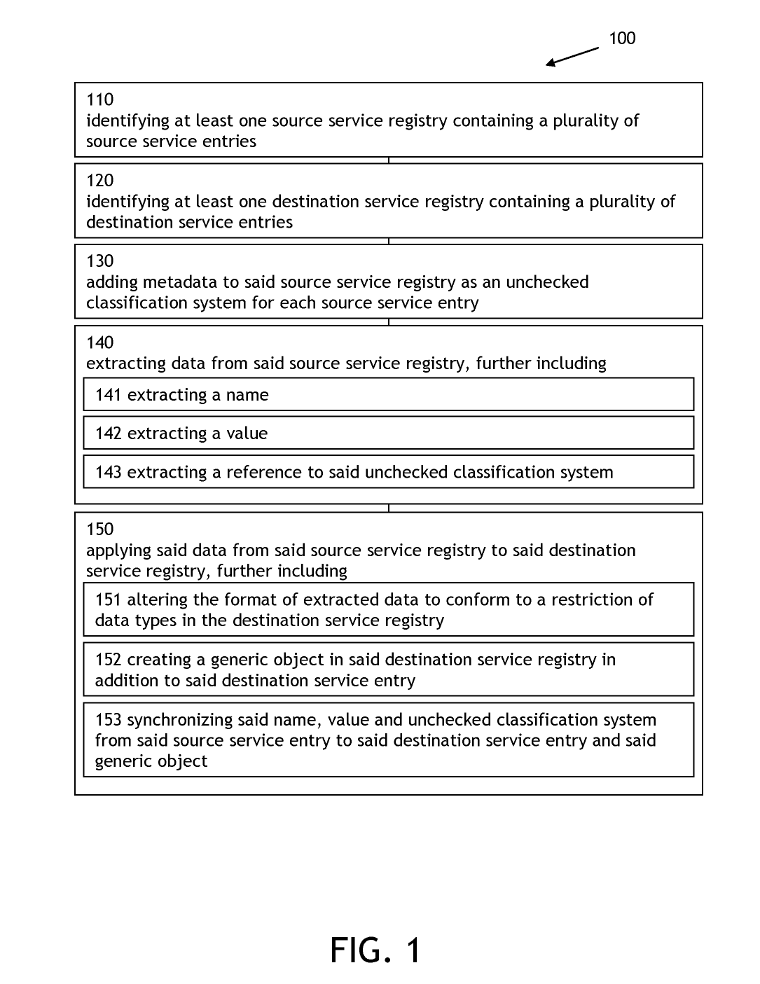

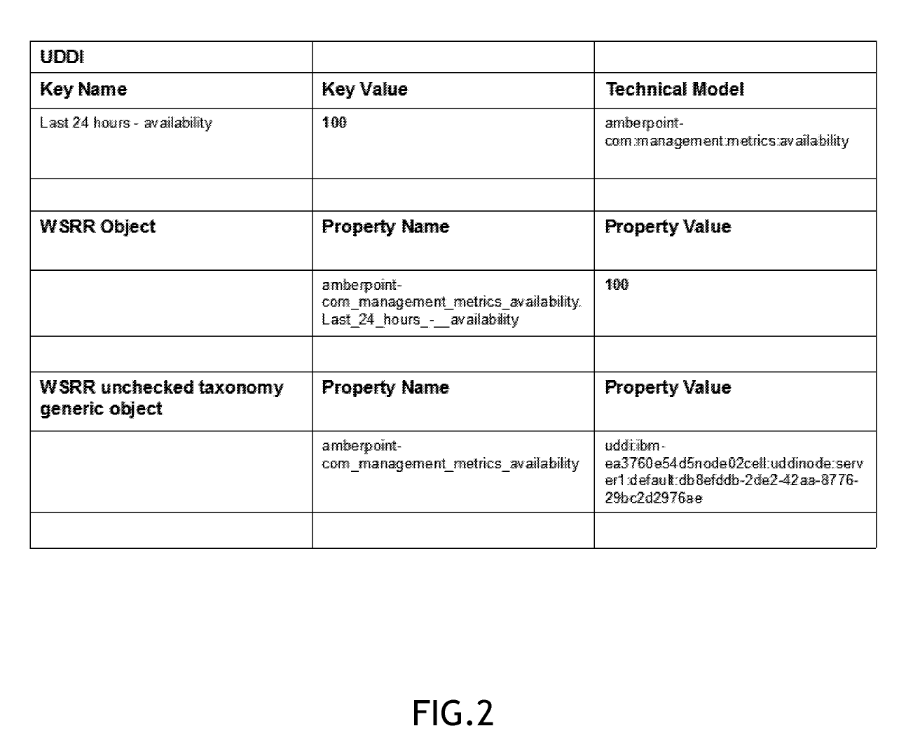

Referring to FIG. 1, the present invention 100 may provide for supporting unchecked classifications within a service registry by manipulating the content and structure of both a source and a destination service registry to allow for proper synchronization of all the desired data. In a preferred embodiment of the present invention, 100 may identify at least one source service registry and at least one destination service registry, each containing a plurality of service entries (also known as objects), as subjects of synchronization 110-120. For example, a source registry may be a UDDI based registry including data such as a Key Name, a Key Value and a Technical Model where the destination service registry may be a WSRR (FIG. 2). The source service registry may allow for the addition of metadata in the form of unchecked taxonomy to a source service entry for proper synchronization to occur. The added metadata to the source service entry may consist of an unchecked classification system for each source service entry 130. The added metadata to the source service entry may also exist in various forms appropriate to the registry. For example as properties in a WSRR, a name and value or a classification system with well defined values in a Web Ontology Language (OWL) file. The allowable value of the name of a property may be limited by the requirements of the destination registry (E.G., a No Colon (NC) Name). The classification system may allow for the proper transfer of additional unchecked classification data between service registries not possible in prior art. For example, a data transfer from a UDDI based registry to a WSRR registry would result in only the Property Name and Property Value data fields being filled in the WSRR object since a WSRR property may only allow for a pair of data fields to be attached to an object (FIG. 2). With the implementation of the preferred embodiment of the present invention detailed below, additional data may be synchronized.

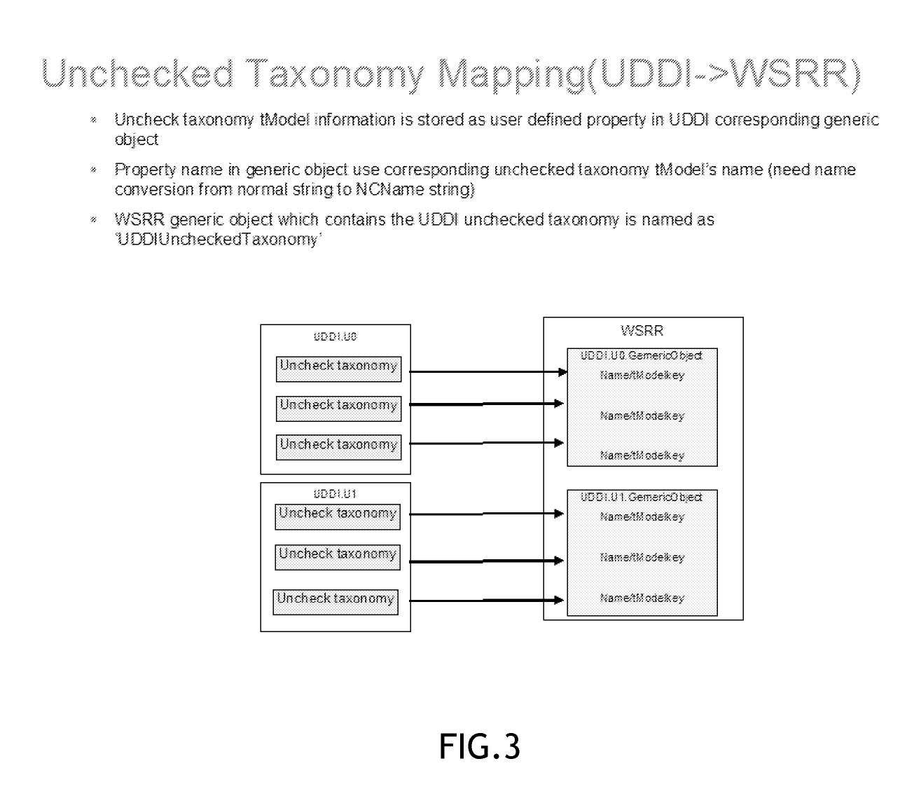

The present invention may preferably extract data from the source service entry 140 consisting of at least a name 141, a value 142, and the added metadata in the form of a reference to the unchecked classification system 143. Method 100 may apply extracted data from the source service registry to the destination service registry 150. In some destination service registries there may be a limited number of fields available for unchecked taxonomy mapping. For example, in a WSRR property, only the data pairs of a name and value are available for data input and any additional metadata from a source registry would be ignored when synchronized with the WSRR. If, for example, a UDDI registry was synchronized and imported into the WSRR, only the property name and property value may be added to the WSRR and valuable taxonomy data from the UDDI may be left unused after the sync (FIG. 2). The present disclosure may preferably create an additional generic object in the destination service registry for mapping of additional unchecked metadata 152. With the newly created generic object in place, additional mapped locations for data are created allowing for additional metadata to synchronize between registries (FIG. 3). Unchecked taxonomy tModel information (a data structure representing a service type) may preferably be synchronized using this invention whereas this data may not have previously been available for transfer (FIG. 3).

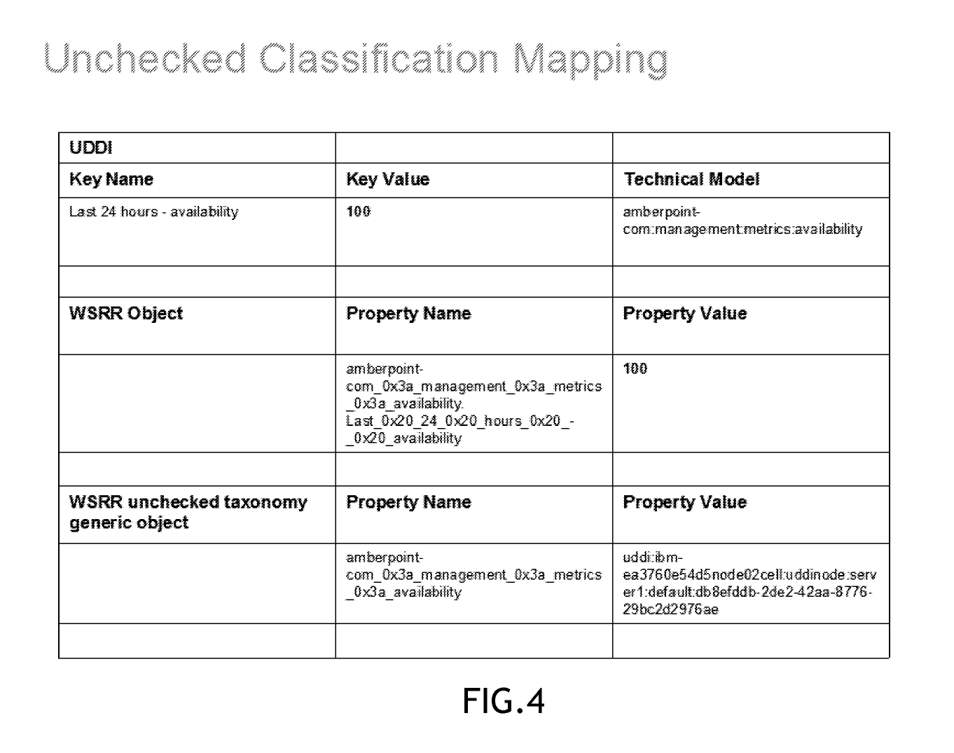

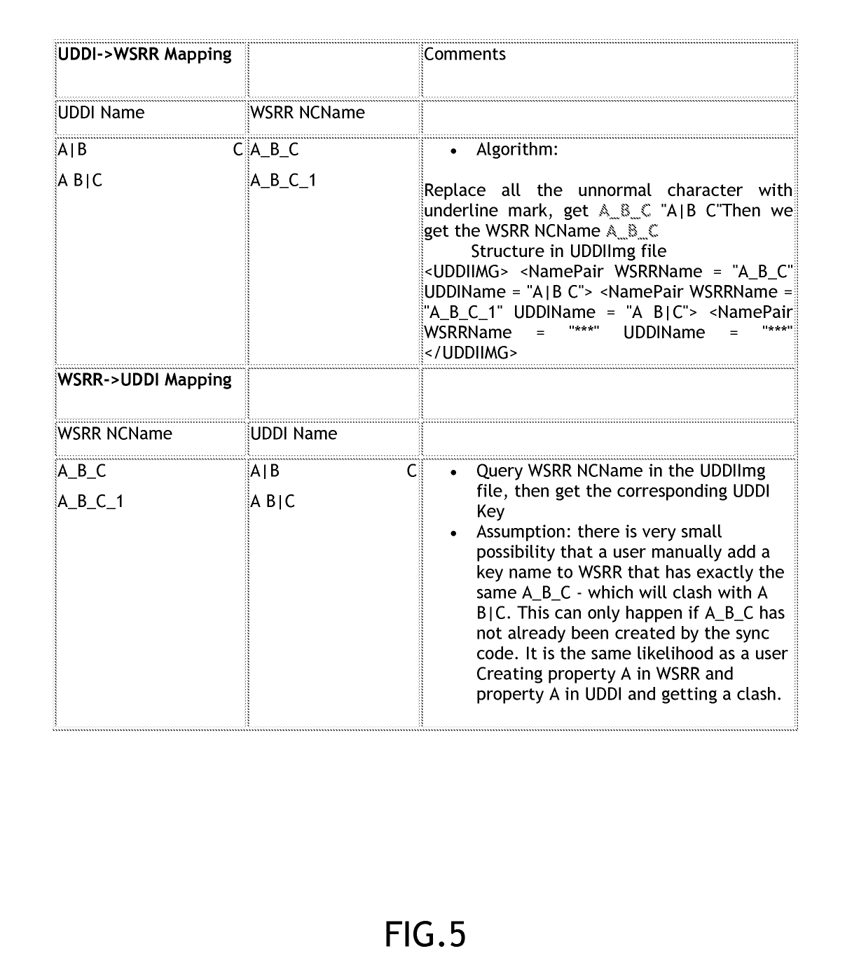

The present invention may also preferably alter the format of extracted data to conform to a restriction of data types in the destination service registry 151. An alteration may include replacing characters not supported by the destination service registry format 151. For example, in unchecked classification mapping a UDDI registry to a WSRR, the data must conform to the NCName format in the WSRR where the non-conforming characters are replaced with underscores (FIG. 2) or character mapping keys (FIG. 4). Method 100 may track properties applied to data during the format alteration listing the keys used to format the data (FIG. 5). For example, an extensible markup language (XML) document referred to as a UDDIImg file may be used to track the alterations made during a UDDI to WSRR synchronization. Method 100 may synchronize the name, value and unchecked classification system from the source service entry to the destination service entry and said generic object 153. The data may be altered to conform to the destination service registry requirements, the data may be mapped to provide for a source data location mapped to a corresponding destination data location, and the data may be synchronized to provide no data loss in the transfer between service registries.

In the present disclosure, the method disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A computer implemented method for supporting unchecked classifications within a service registry comprising:
identifying at least one source service registry containing a plurality of source service entries;
identifying at least one destination service registry containing a plurality of destination service entries;
adding metadata to said source service registry as an unchecked classification system for each source service entry;
extracting data from said source service registry, further including:
extracting a name,
extracting a value, and
extracting a reference to said unchecked classification system;
applying said data from said source service registry to said destination service registry, further including:
altering the format of extracted data to conform to a restriction of data types in said destination service registry,
creating a generic object configured to conform to said restriction of data types in said destination service registry in addition to said destination service entry, and
synchronizing said name, said value and said unchecked classification system from said source service entry to said destination service entry and said generic object, wherein said unchecked classification system is applied to said generic object.
